(19) United States
(12) Patent Application Publication
(10) Pub. No.: US 2012/0285794 A1
(43) Pub. Date: Nov. 15, 2012

(54) AUTOMATED COIN OPERATION SHARE ALLOCATION DEVICE

(75) Inventors: LAYNE R. UPTON, COLLINS, MS (US); W. Lovelle Upton, Collins, MS (US)

(73) Assignee: ISM, Inc.

(21) Appl. No.: 13/470,351

(22) Filed: May 13, 2012

Related U.S. Application Data
(60) Provisional application No. 61/485,951, filed on May 13, 2011.

(51) Int. Cl. G07F 1/04

(52) U.S. Cl. 194/344

(57) ABSTRACT

A coin operated air compressor providing compressed air with a share splitter for diverting the proceeds from deposited coins into separate collection bins according to predetermined ratio(s).

### RELATED APPLICATION

This application claims priority benefit of U.S. Provisional Application Ser. No. 61/485,951 filed on 13 May 2011.

### TECHNICAL FIELD OF THE INVENTION

The present invention generally relates to coin operated vending machines. More particularly the invention relates share allocation for coin operated compressed air stations and shared use of the coin operated detection system by a plurality of devices

### BACKGROUND OF THE INVENTION

In many communities the motoring public is underserved with respect to compressed air for maintaining proper air pressure in automotive tires. Maintaining tire pressure is a significant safety concern both for drivers and passengers in the subject vehicle and to other vehicles on the road. One of the issues relating to these pumps relates to monitoring the operational status of the devices. There is a need for devices which encourage monitoring of the operation of the devices.

A benefit of embodiments described herein is providing the user with an alternative for obtaining benefit from unused pump time by allowing the user to switch the time value remaining to other power tool(s) such as a vacuum cleaner.

FIG. 1 illustrates a prior art 10 coin operation component of a compressed air pump machine. The components including a housing 11 which includes a coin receiving component 13, a coin detection component 21 and a coin storage component 31. The system shown employs standard coin receiving slot(s) 15 and a coin return 23. The coin detection component includes systems which identify valid coins and employs a coin detection controller 25 for rejecting invalid coins and for sending control signals initiating operation of the compressed air pump when valid coin(s) in the correct amount are detected. When valid coins are received they are deposited in a hopper (not shown) The coin hopper is accessible via a access door 33 secured by a locking mechanism 35.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a prior art coin operated control system;

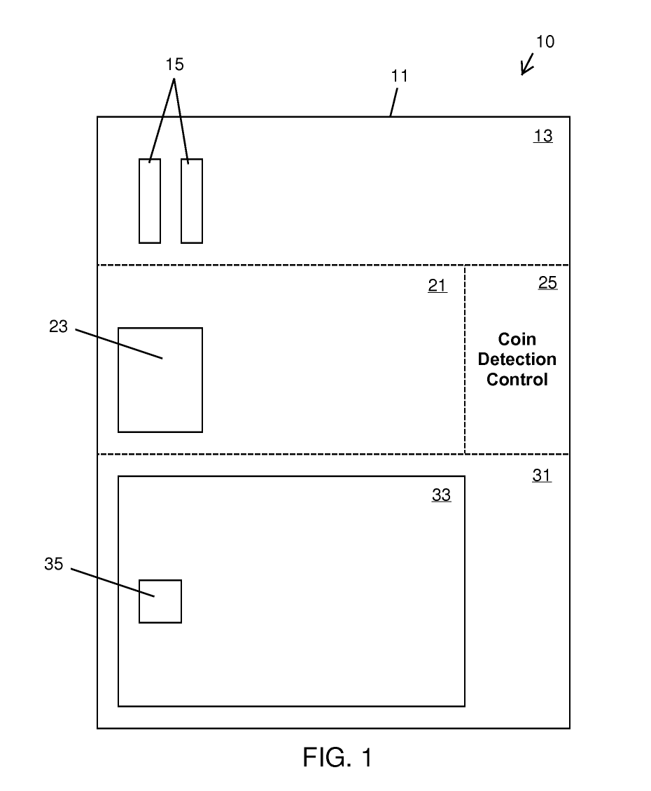

FIG. 2 illustrates an automated system for share distribution of a coin operated vending control system;

FIG. 3 illustrates an isometric view of an automated share allocation device as per FIG. 2;

FIG. 4 illustrate a top perspective view of the device illustrated in FIG. 3;

FIG. 5 illustrates a perspective view of the flapper of the device illustrated in FIG. 3 and FIG. 4;

FIG. 6 illustrates an isometric view of the front half of the share distribution hopper illustrated in FIG. 3 and FIG. 4;

FIG. 7 illustrates an alternative embodiment of an automated system for share distribution; and

FIG. 8 illustrates an embodiment of a selection and sensor and power connections for the vending system.

### DETAILED DESCRIPTION OF THE INVENTION

Preferred embodiments of the present invention are illustrated in the FIGUREs, like numerals being used to refer to like and corresponding parts of the various drawings.

The present invention generally relates to coin operated vending machines particularly coin operated air compressor vending machines. The improvement to prior art devices is to automatically divide the proceeds from the coin operated vending system. Some of the advantages of this system are: it provides for instant commissions or splits of the proceeds of the vending machine; it allows for instant verification of the correct split percentage by empting one of the hoppers and depositing coins to observe the split. It allows for fewer trips to the machine to collect proceeds, avoids the costs of splitting the proceeds; provides motivation for the commissionee to make sure that the device is operational and let the operator know if the machine needs servicing so that operator can send service techs when they are needed saving operator costs in allocation of resources. The system allows for adjustment to the share percentages, adjustment to the time value for the detected payment and adjustment to the weighting of time based on the device selected (for embodiments that allow for switching between different powered tools.

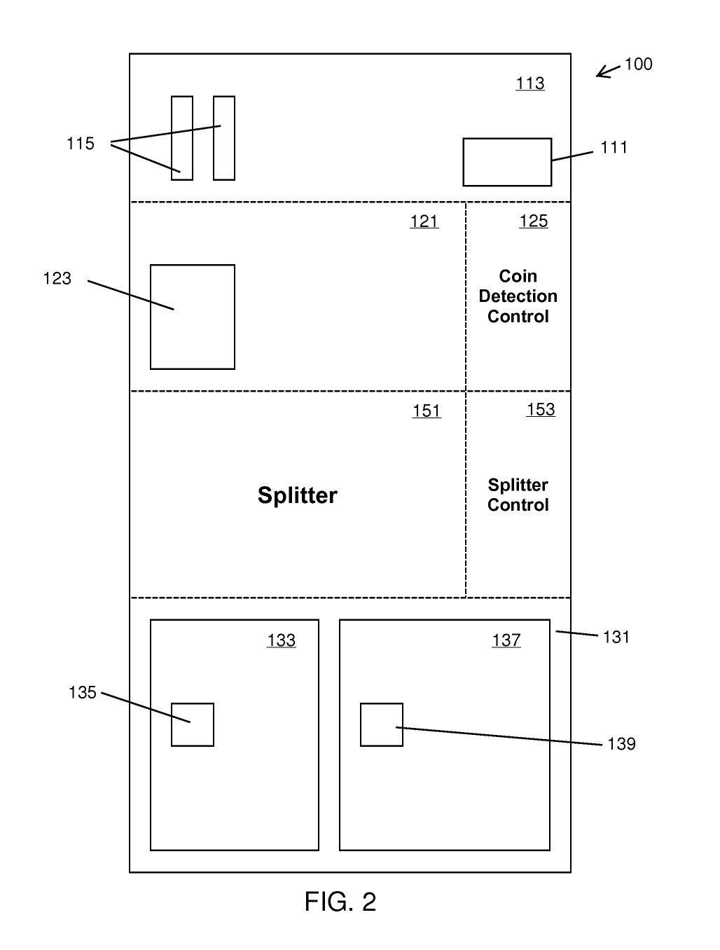

FIG. 2 illustrates an embodiment of an automated system for share distribution of a coin operated vending control system. The system is a vending machine which employs a coin operation subsystem 100. The coin operation subsystem includes conventionally available means for receiving coins 113; a conventional coin detection subsystems 121 and secured access coin storage 131 for storing the received coins (not shown). In the embodiment shown these components are all in a single housing but that this is not necessary. In the embodiment shown the coin detection control system 125 and coin allocation control system 153 are separate devices. In other embodiments these control system functions may be embodied in a single controller performing both functions. The coin operation subsystem 100 illustrated includes: slot(s) 115 for receiving coins; a coin return 123 for rejected coins and/or change. Other conventional means for receipt and return of coins are likely. The coin storage 131 section has separately securable chambers with respectively separate access doors 133 and 137 which are secured by different locks 135 and 139 respectively. These access doors 133 and 137 provide access to separate coin baskets/drawers (not shown). In practice divided shares of the proceeds are accessible from the coin hoppers secured by the access door locks 135, 139.

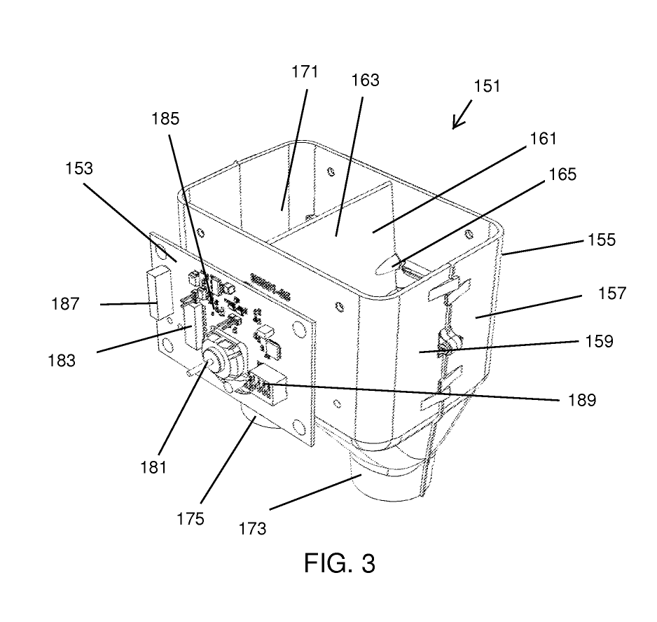

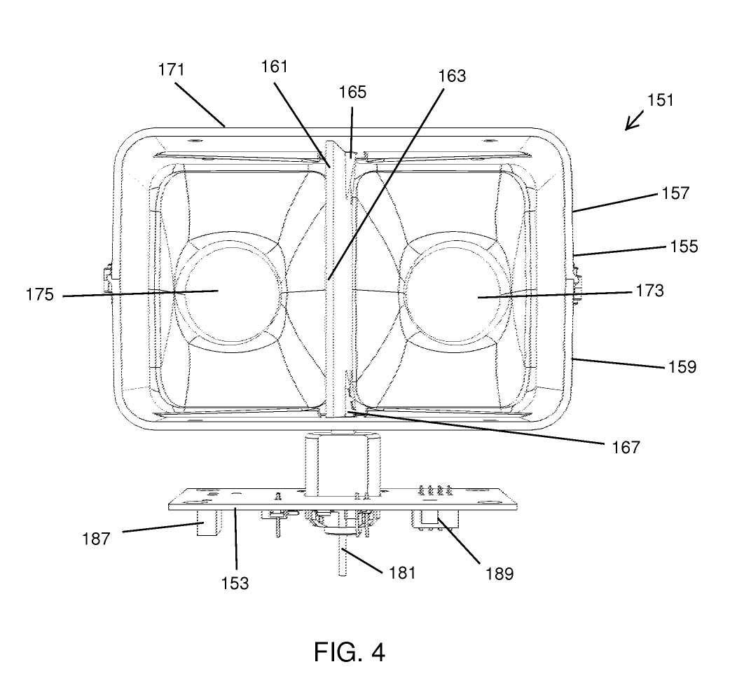

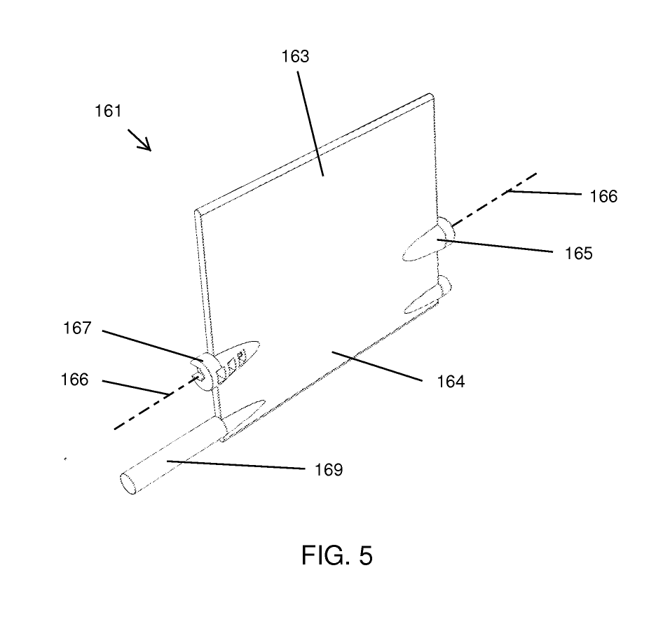

FIG. 3 illustrates an isometric view of an automated share allocation device 151 in greater detail. The major components of the device are a hopper 155, a flapper 161 and, control circuit 153. In the embodiment illustrated, the hopper is composed of two parts front 159 and back 157. The flapper 161 is sandwiched between the front 159 and back 157 of the hopper 155 pivoting on pivots 165 and 167 (as seen in FIG. 4 and FIG. 5). The hopper 155 has en entry port 171 on the top and two exit ports 173 and 175 respectively. Coins fall into the entry port 171 and exit one of the exit ports 173 or 175. Which port serves as the exit port depends on the position of the flapper 161.

FIG. 3 also illustrates an embodiment of the control circuit 153 of the allocation system 151. The control circuit includes a processor 183 which includes data and instruction data storage and logic processing capabilities. It also includes a motor 181 which drives the rotation of the flapper 161 about pivots 165 and 167 (as seen in FIG. 4 and FIG. 5). In the embodiment shown the motor 181 is a stepper motor in alternative embodiments other types of drives are possible such as linear drives and/or servo-motors and or solenoids would also be suitable. The control circuit also includes appropriate drive circuitry 185. In addition the circuitry includes power and data connector 187 for powering the control circuit and communicating with other vending systems such as the coin detection control circuit and for programing and diagnostics. The control circuitry also includes DIP (dual inline package) switches 189 for programing the operation of the control circuit 153. On other embodiments other means for programming would be appropriate.

FIG. 4 illustrates a top perspective view of the hopper 155 illustrated in FIG. 3.The view is down through the entry port 171 and through the two exit ports 173 and 175 of the hopper 155 are easier to see. This view also provides a different perspective of the motor's 181 connection to the flapper 161 to pivot about pivots 167 and 165. In operation if the flapper 161 is pivoted so the top edge 163 of the flapper 161 is to the left the coins will exit port 173. On the other hand, if the flapper 161 is pivoted by the motor 181 so that the top edge 163 of the flapper 161 is to the right the coins will exit port 175.

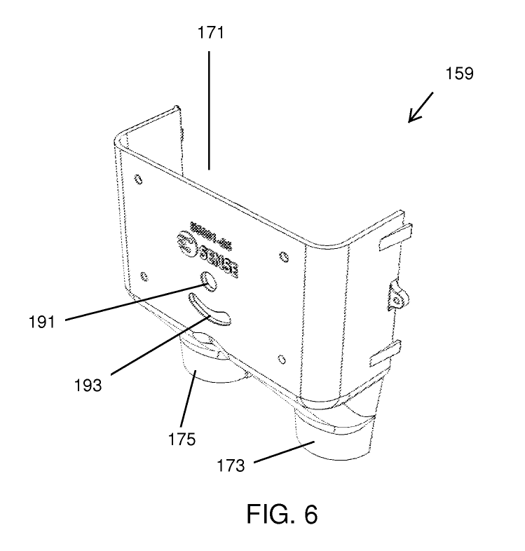

FIG. 5 illustrates a perspective view of the flapper 161 of the device illustrated in FIG. 3 and FIG. 4. The pivots 167 and 165 pivot the flapper 161 about pivot axis 166 driving the top edge of the flapper 163 to the left or right this diverting the coins out of the exit port designated by the position of the flapper 161 in the hopper 155. In this embodiment the motor drive (shown in FIG. 4 and FIG. 3) is connected to the flapper 161 at pivot 167. FIG. 5 also illustrates the pivot stopp 169 which works with a slot 193 in the front face of the hopper 159 shown in FIG. 6 to stop or set the pivot positions of the flapper 161 (shown in FIG. 4 and FIG. 3) to determine the exit port 173 or 175 for the dropping coins.

FIG. 6 also illustrates the setting 191 for pivot 167 of the flapper 161 (shown in FIG. 4 and FIG. 3).

In operation of the embodiment shown, the control circuit 153 receives signals from the coin detection controller 125. The control circuit 152 keeps a count of the accepted coins received. Using this count the control circuit shifts the flapper to allocate the proceeds in the form of received coins to either exit port 173 or 175. Coins that exit port 173 are collected in a coin basket/drawer (not shown) accessible via access door 137 secured by locking mechanism 139. Coins that exit port 175 are collected in a coin basket/drawer(not shown) accessible via access door 133 secured by locking mechanism 135. The DIP switches 189 can be sued to set the allocation ratios/percentages such as 50% or 20% by way of example. In the case of fifty cents the flapper may shift after every purchase or it may shift after equal number of purchase such as 10 and then shift again after 10. For 20 percent the flapper may shift after 4 purchases and then shift to the other side and then shift again after on purchase and so on. By allowing for a automated divided allocation of the proceeds a store owner or agent may be provided with access to one of the allocations of the proceeds to provide motivation to monitor and/or maintain the operation of the vending device. In the embodiment shown the allocation protocol can be set with the DIP switches 189 or by means of programming the processor via the data connection ports 187.

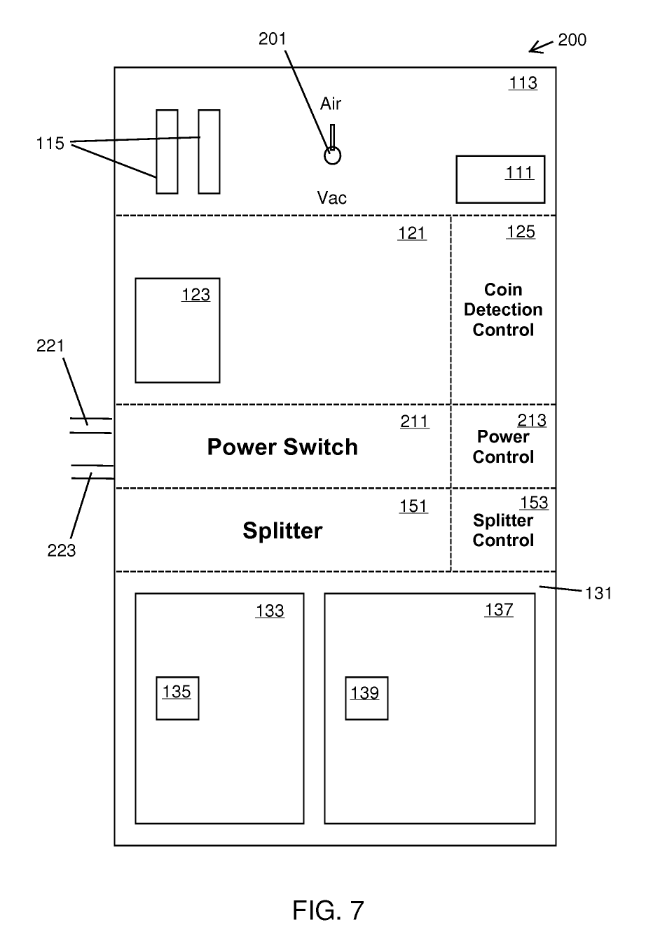

FIG. 7 illustrates an alternative embodiment of an automated system for share distribution 200. This embodiment includes a user interphase 201 for selecting from a multible devices. The embodiment illustrated employs a toggle, other embodiments may employ buttons or dials or other similarly known user selection interfaces. In the embodiment shown the user may use the air compressor to pump up her tires and if she has any time left can switch over to a vacuum cleaner to use up any extra time. In alternative embodiments the user may be able to select from other devices or a wider array of devices such as a water pump. This embodiment includes a display 111 for showing the time remaining and a power switch 211 which is responsive to a power controller 213 which is responsive to the user selection interface 201 to power the selected device and remove power from the other devices. For example the switch may apply power across power lines 221 when the air compressor is selected and no power across lines 223 to the vacuum. When the user switches the selection the power may be applied across lines 223 and may be removed from across power lines 221 and removed from lines 221.

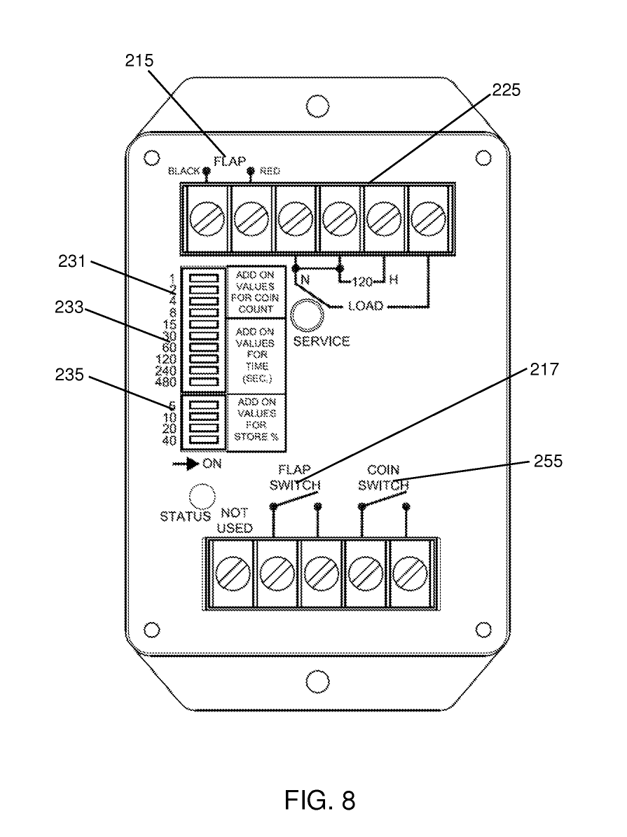

FIG. 8 illustrates an embodiment of a selection and sensor and power connections for the vending system. This embodiment illustrates input connections from a coin detection circuitry 255 and from a flap position sensor 217. It also illustrates connectors for powering flipping of the flap 215 and for providing power to alternative devices 225. In the embodiment illustrated the control adjustments can be made by means of DIP switches 231, 233 and 235 for respectively adjusting the add on value of time, the value of time for detected coin counts and for adjusting the allocation splits effected by the allocation hopper.

The control routines allow for different time value weightings for remaining time value based on the device being driven. For example, Fifty cents may equate to twice the time with the vacuum as with the air compressor. So if there is one minute remaining on the display and the user switches to vacuum the time will be recalculated and the user will be allocated two minutes of vacuum time which will be reflected on the display as two minutes. Additionally in some embodiments the user is not debited for time when the compressor is building up to operation pressures. However, in these embodiments the compressor will time out if it does not reach or maintain predetermined operating pressure(s).

In some embodiments the vending machines also include communication modems for transmitting and receiving information and instructions from a remote location. Information may include collection and service activities, GPS coordinates, forcing the diverter to a home position, cycle counts, coin basket/drawer accesses.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations canbe made hereto without departing from the spirit and scope of the disclosure.

What is claimed is:

1. A coin operated air-compressor vending machine comprising:
a share splitter which diverts deposited coins among a plurality of collection bins each with separate access doors for collection of split proceeds.
